(19) United States
(12) Patent Application Publication
(10) Pub. No.: US 2015/0114584 A1
(43) Pub. Date: Apr. 30, 2015

(54) ROLL COVER AND METHOD FOR THE PRODUCTION THEREOF

(71) Applicant: VOITH PATENT GMBH, HEIDENHEIM (DE)

(72) Inventor: Michael Wokurek, Wien (AT)

(21) Appl. No.: 14/377,376

(22) PCT Filed: Jan. 30, 2013
(86) PCT No.: PCT/EP2013/051748

§ 371 Date: Dec. 9, 2014

(30) Foreign Application Priority Data
Feb. 7, 2012 (DE) 10 2012 201 782.8

(51) Int. Cl. D21F 3/08; C08L 75/06

(52) U.S. Cl. CPC D21F 3/08; C08L 75/06
USPC 162/205; 525/460; 162/361

(57) ABSTRACT

A roll covering is particularly suited for use in the press section of a machine for the production of a web of fiber-based material, for example a papermaking machine, a paperboard machine, or a tissue machine. The roll covering is arranged on a roll core which, in particular, is composed of metal or of a fiber-composite material. The modulus of elasticity of the roll covering is from 500 to 1500 N/mm².

The invention relates to a roll covering in particular for use in a press section in a machine for the production of a web of fiber-based material, for example a papermaking machine, paperboard machine, or tissue machine as in the preamble of claim 1, and also to a process for the production of a roll covering of this type as in the preamble of claim 10.

Press roll coverings with a modulus of elasticity in the range from 50 to 500 N/mm² made of polyurethane elastomers are prior art.

By way of example, EP 2 118 164 discloses a process for the production of a roll jacket or roll covering of a roll made of an NDI-based polyurethane. The intention here is to overcome lack of green strength as quickly as possible in order to avoid stress cracking, in that the hardener added to the polyurethane reduces pot life to from 5 to 60 s. An NDI polyurethane is moreover also described for the production of a roll jacket or roll covering of a roll.

In some applications, in particular in locations with high press loadings of more than 100 kN/m, in the case of high machine speeds or high chemicals loading in the material the known coverings give very high wear rates and therefore unsatisfactorily short grinding intervals.

Accordingly it is an object of the invention to provide a roll covering which has improved wear resistance for applications subject to very high loads. A process is moreover provided for the production of a covering of this type.

The object is achieved in respect of the roll covering via the characterizing features of claim 1, and in respect of the process via the characterizing features of claim 10, in each case in conjunction with the generic features.

This invention provides that the modulus of elasticity of the roll covering is from 500 to 1500 N/mm². This can be achieved via an appropriate two-stage curing process. The resultant roll covering has a high degree of crosslinking and therefore has a high modulus of elasticity and high hardness. The operating time of the roll covering can thus be improved significantly.

The dependent claims provide other advantageous aspects and embodiments of the invention.

The roll covering advantageously has at least one polymer layer which is composed of a resin-hardener mixture.

The resin can preferably be a reaction product of a first relatively reactive diisocyanate, of a second less reactive diisocyanate, and of a diol, in a molar ratio of at least 2:1. The components mentioned allow a higher degree of crosslinking and a two-stage curing process.

With particular preference here, the first diisocyanate can be a reactive diisocyanate, and the second diisocyanate can be an unreactive diisocyanate. Surprisingly, the roll coverings produced from this combination have excellent properties for use in locations subject to high loads in high-speed machines running webs of fiber-based materials.

The reactive diisocyanate is advantageously selected from: MDI (methylenediphenyl diisocyanate), PPDI (p-phenylene diisocyanate), TDI (toluene 2,4-diisocyanate), NDI (naphthylene diisocyanate), and other aromatic compounds.

The unreactive diisocyanate is advantageously selected from: HMDI (methylenebis(4-isocyanatocyclohexane)), CHDI (cyclohexyl 1,4-diisocyanate), HDI (hexamethylene 1,6-diisocyanate), IPDI (isophorone diisocyanate), and other aliphatic compounds.

The hardener can advantageously comprise a preparation made of differently reactive diamines and diols.

In one advantageous aspect of the process of the invention, the roll covering is subjected to a two-stage curing process. There is no need for application of a plurality of layers, or for use of a variety of materials in a variety of operations.

It is in particular advantageous that in a first step a modulus of elasticity of from 50 to 500 N/mm² is achieved via a first hardening reaction. Since these values are achievable by means of the processes commonly used currently for the production of polymeric roll coverings, the known processes can be used in order to produce the precursor of the finished product. Advantageously, there is no need for expensive purchase of other machines.

It is moreover advantageous that in a second step a modulus of elasticity of from 500 to 1500 N/mm² is achieved via a second hardening reaction, and this second step uses thermal post-treatment at 120 for at least 48 hours. Here again, there is no need for any expensive specialized equipment, since the desired properties of the material can be established via the reactivity of the components of the mixture.

The roll covering can preferably be produced via a cast-application process, in particular via a ribbon-flow process.

In one advantageous aspect of the invention it is possible to produce the casting composition forming the roll covering via production of a mixture of a first diisocyanate, a second diisocyanate, and a diol, where the sequence of mixing of the components is as desired.

The invention is explained in more detail below with reference to a preferred embodiment.

The problem indicated above can be solved via a particularly hard roll covering made of polyurethane, the modulus of elasticity of the covering being in the range from 500 to 1500 N/mm². Roll coverings of this type exhibit sufficiently little deformation of the surface structure even under very high loads, and therefore also exhibit sufficiently good wear resistance with satisfactory grinding intervals and satisfactory covering-replacement intervals.

The person skilled in the art is confronted by particular technical difficulties in the production of a covering of this type. A particularly difficult issue in the manufacture of very hard plastics-based roll coverings on a metal body such as a roll core is control of intrinsic stresses which arise because of the different coefficients of thermal expansion of the bonded materials and because of volume shrinkage during the hardening reaction.

The problem can be solved in the invention via a two-stage hardening reaction. The occurrence of stresses resulting from volume shrinkage can thus be separated chronologically from the occurrence of stresses due to the different coefficients of thermal expansion, and the level of intrinsic stress effectively occurring can thus be lowered to an extent that avoids cracking in the roll covering during and after the manufacturing process.

The first stage of the hardening reaction gives a material with a modulus of elasticity in the range from 50 to 500 N/mm². The application of the material on is the roll core is achieved here via what is known as a ribbon-flow process, which uses a displaceable casting head to apply the liquid polyurethane onto the roll core, which rotates continuously under the casting head. The process is known per se, and no detailed description thereof is therefore required here.

The casting composition is blended in the casting head, and is typically composed of two components. A first component (an isocyanate or resin) is a preparation made of a PU prepolymer. The PU prepolymer is a reaction product of a diisocyanate and a macromolecular diol in a molar ratio of 2:1 or greater, and of a diisocyanate.

In this invention, the distinct two-stage reaction sequence is a necessary result of use of two different diisocyanates which have very different reactivity. Reactive diisocyanates used are aromatic compounds such as MDI (methylenediphenyl diisocyanate), PPDI (p-phenylene diisocyanate), TDI (toluene 2,4-diisocyanate) or NDI (naphthylene diisocyanate). Unreactive diisocyanates used are, in contrast, aliphatic compounds such as HMDI (methylenebis(4-isocyanatocyclohexane)), CHDI (cyclohexyl 1,4-diisocyanate), HDI (hexamethylene 1,6-diisocyanate) or IPDI (isophorone diisocyanate). It is particularly advantageous to construct the PU prepolymer from a macromolecular diol and a reactive diisocyanate, and then to blend this with an unreactive diisocyanate.

A second component (a hardener or crosslinking agent, or chain extender) is composed of a preparation of differently reactive diamines and diols. The immediate pot life of the casting composition is adjusted by way of the proportions by mass and the reactivities of the constituents of this component. The pot life here is selected in such a way that the casting composition on the one hand hardens at an appropriately fast rate, and does not drip during the application process, and on the other hand still has a level of reactivity and viscosity that ii brings about wetting, flow, and reaction with respect to the next polymer ribbon, which is abutted alongside the preceding ribbon. In this step it is mainly the reactive diisocyanates and the reactive hardener components that react.

The pot life is measured here by the following method: once the two-component is casting machine is ready to use and has been calibrated, freshly mixed two-component casting elastomer is cast from said machine into a plastics beaker for 3 seconds, and is continuously stirred by a wooden spatula; the spatula is repeatedly withdrawn at 5-second intervals, and the flow behavior of the continuously hardening casting composition is observed here as it flows from the spatula. The time from the start of stirring to the juncture at which the composition hardens from a high-viscosity liquid to become a self-supporting paste is termed the pot life. The method described is known to the person skilled in the art with relevant training in the field of polymer chemistry. This is a method conventionally used in the industrial sector when producing roll coverings from polymer.

The second stage of the curing reaction takes place during a thermal post-treatment of the plastics covering thus applied. The low-reactivity components of the mixture react during this step. The modulus of elasticity rises here by at least an order of magnitude required for the range of the invention: from 500 to 1500 N/mm².

The intrinsic strength, and elongation at break, of the casting composition at this juncture are already sufficiently high in the invention to prevent any destruction of the structure of the covering due to the intrinsic thermal stresses that occur during the thermal post-treatment and especially on cooling.

A mixture for a preferred embodiment of the invention is stated below:

The following mixture is used as isocyanate component:
90 parts of Adiprene RFA 1201
10 parts of Desmodur W

Adiprene RFA1201 here is a prepolymer formed from PTMEG 1000 and MDI with 11.5% NCO content. Desmodur W is technical-grade HMDI, and is the low-reactivity component in this system.

The following mixture is used as hardener component:
84 parts of Lonzacure MCDEA
10 parts of Lonzacure MDIPA
6 parts of Amicure PACM

The two components are mixed by way of a two-component casting machine in a ratio of about 100 parts of prepolymer to 55 parts of hardener mixture, and, with use of a slot die, are cast in a spiral onto the rotating roll body, which usually is provided in advance with a specific adherent layer. The precise mixing ratio of the components is calculated after measurement of the NCO content in such a way that the molar ratio of reactive H atoms in the hardener to NCO groups in the isocyanate resin is about 0.93 to 0.97, preferably 0.95, i.e. there is a slight excess of the NCO groups.

The first reaction step here has been completed after as little as a few minutes after the application process. The post-curing of the less reactive constituents still present is achieved via a thermal post-treatment of the workpiece in a hot-air oven at a 120 C for a period of at least 48 hours.

1-14. (canceled)

15. A roll covering, comprising:
a roll covering for a roll core, said roll covering having a modulus of elasticity from 500 to 1500 N/mm²;
said roll covering including at least one polymer layer composed of a mixture of resin and a hardener;
said resin being a reaction product of a first diisocyanate and a diol in a molar ratio of at least 2:1, mixed with a second diisocyanate, said first diisocyanate being a reactive diisocyanate and said second diisocyanate being a less reactive or unreactive diisocyanate.

16. The roll covering according to claim 15, wherein said roll covering is configured for a roll in a press section of a machine for the production of a web of fiber-based material selected from the group consisting of a papermaking machine, a paperboard machine, and a tissue machine.

17. The roll covering according to claim 15, wherein said reactive diisocyanate is selected from the group consisting of MDI (methylenediphenyl diisocyanate), PPDI (p phenylene diisocyanate), TDI (toluene 2,4-diisocyanate), NDI (naphthylene diisocyanate), and other aromatic compounds.

18. The roll covering according to claim 15, wherein said less reactive or unreactive diisocyanate is selected from the group consisting of HMDI (methylenebis(4-isocyanatocyclohexane)), CHDI (cyclohexyl 1,4-diisocyanate), HDI (hexamethylene 1,6-diisocyanate), IPDI (isophorone diisocyanate), and other aliphatic compounds.

19. The roll covering according to claims 15, wherein said hardener comprises a preparation made of differently reactive diamines and diols.

20. A process for the production of a roll covering according to claim 15, which comprises subjecting the roll covering to a two-stage curing process.

21. The process according to claim 20, wherein the two-stage curing process includes a first step in which a modulus of elasticity of from 50 to 500 N/mm² is achieved via a first hardening reaction.

22. The process according to claim 20, wherein the two-stage curing process includes a second step in which a modulus of elasticity of from 500 to 1500 N/mm² is achieved via a second hardening reaction.

23. The process according to claim 22, wherein the second step comprises carrying out a thermal post-treatment at 120° C. for at least 48 hours.

24. The process according to claim 20, which comprises forming the roll covering by carrying out a cast-application process.

25. The process according to claim 24, which comprises forming the roll covering by carrying out a ribbon-flow process.

26. The process according to claim 24, which comprises producing a casting composition for the roll covering by producing a mixture of a first diisocyanate, a second diisocyanate, and a diol, and thereby arbitrarily selecting a sequence of mixing the components.

27. A roll, comprising:
a roll core composed of metal or of a fiber-composite material; and
a roll covering according to claim 15 disposed on said roll core.

28. In a machine for the production of a web of fiber-based material selected from the group consisting of a papermaking machine, a paperboard machine, and a tissue machine, a press section of the machine, comprising:
a roll core composed of metal or of a fiber-composite material; and
a roll covering according to claim 15 disposed on said roll core.

29. A processing method, which comprises providing one or more rolls according to claim 27 in a press section of a machine selected from the group consisting of a papermaking machine, a paperboard machine, and a tissue machine, and processing a web of fiber-based material in the press section of the machine.

30. A processing method, which comprises providing one or more rolls with a roll covering according to claim 15 and processing a web of fiber-based material with the one or more rolls in a machine selected from the group consisting of a papermaking machine, a paperboard machine, and a tissue machine.
